(19) United States
(12) Patent Application Publication
(10) Pub. No.: US 2024/0240019 A1
(43) Pub. Date: Jul. 18, 2024

(54) Critter Resistant Electrical Control Box for Use Outdoors

(71) Applicant: CorrSolve Corrosion Solutions LLC, Fort Worth, TX (US)

(72) Inventors: Steve Tosh, Aledo, TX (US); Leonel Rodriguez, Arlington, TX (US); Chad Knight, Dodd City, TX (US); Mike Dry, Fort Worth, TX (US); Jeff Busby, Millsap, TX (US)

(21) Appl. No.: 18/394,210

(22) Filed: Dec. 22, 2023

Related U.S. Application Data
(63) Continuation of application No. 17/065,692, filed on Oct. 8, 2020, now abandoned.
(60) Provisional application No. 62/887,318, filed on Aug. 15, 2019.

(51) Int. Cl. C08L 75/04; A01M 29/30; B05D 1/02; C08L 75/02; H02G 3/08

(52) U.S. Cl. CPC C08L 75/04; A01M 29/30; C08L 75/02; H02G 3/081; B05D 1/02; C08G 2190/00

(57) ABSTRACT

An electrical control box for outdoor use that has a number of sealants provided to help prevent moisture from causing corrosion to the components inside the box, as well as providing resistance to attack of the box by critters, such as raccoons, mice, and the like. In some embodiments, a curable polyurethane is used.

This application is a continuation of, and claims the benefit of, priority to, and incorporates by reference, pending application Ser. No. 17/065,692, filed Oct. 8, 2020, which, in turn, claims the benefit of, priority to, and incorporates by reference provisional application No. 62/887,318, filed Aug. 15, 2019.

### FIELD OF THE INVENTION

Critter resistant control boxes, more specifically, control boxes and modifications thereof, such as outdoor electrical control boxes at railroad crossings that, in some embodiments, help prevent access to the interior thereof by critters, such as insects and rodents, while, in some embodiments, providing corrosion resistance.

### BACKGROUND OF THE INVENTION

Electrical enclosures usually have cables running into and out, as well as access doors, all providing potential ingress locations for critters.

Rodents, insects, and other animals (collectively “critters”) do not mix well with electrical control boxes. They can get into small spaces looking for food or shelter, and rodents, like skunks, mice, and squirrels, or other animals can often chew through cables with their sharp teeth.

While some solutions, like fencing an area around an electrical control box or other electrical enclosure, have been tried, the results have had only limited success as some critters can crawl, climb. dig or fly.

Critters not only do physical harm in attempting ingress to an electrical control box, their scratching, chewing, and even feces can accelerate chemical corrosion caused, in part, by moisture.

Moreover, control boxes are sometimes subject to the elements and the use of sealants to protect the electrical parts from elements such as moisture can help extend the life of the boxes. Last, plants and microbes can also damage electrical enclosures.

### SUMMARY OF THE INVENTION

Applicant provides, in some embodiments, a multi-step, multi-device approach which provides multiple novel products or devices for use on the exterior and/or the interior of an electrical control box or other electrical enclosure that achieves one or more of the following goals. First, mechanical blockage of the ingress pathways that moisture or critters may use is provided. Second, the use of chemical barriers to hamper critter ingress is provided. Third, in some embodiments, in the same products that help with one or both of mechanical blockage and chemical barrier, corrosion control of a substrate may be achieved by creating a barrier to moisture.

A gasket is provided which combines a skeleton encapsulated in a cured polymer matrix, such as a sticky, soft polymer gel or a harder but still pliable, elastomeric, cured polymer matrix. Such a gasket can be used with or in place of weather stripping on door closure areas or around gaps, in some cases those gaps between electrical wires and at the holes in the control box housings where electrical wire or conduit enters the box.

In addition to or in combination with the gasket, a two-part, applicator applied, deformable cure-in-place injectable, viscous liquid (in the uncured state) polymer may be used to seal openings or to cover and/or encapsulate electrical terminals or exposed areas on the outside or inside of the box, including parts enclosed within the box.

In addition to the gasket and injectable polymer described above, a brush, roller or spray applied, two-part cure-in-place sealant coating may be used. The sealant coating will provide, in some embodiments, an at least partly transparent, thin, pliable sheet that adheres well to the substrate to which it applies and helps prevent moisture from causing corrosion and helps deter critters and impede plant growth.

In addition to the gasket, the injectable polymer and the polymer sealant coating, a tacky, sticky, pre-cured polymer tape may be used, sometimes on perimeter areas that border box housing openings as a wrap or around electrical wires or conduit at or near where they enter the box or enclosure.

All of the sealant devices above: gasket, tape, coating or injectable are made of two-part polymer mixes, the gasket and tape comprising a pre-cured polymer mix and the coating and the injectable, brush, spray or roll-on a mix-and-apply and cure-in-place (on the substrate) polymer mix. All of the polymer matrixes, after curing, may be somewhat pliable or elastomeric and will adhere to a substrate with a water tight and moisture proof bond that is not an adhesive bond, rather may be clearly releasable with some tugging, cutting, pulling, and the like, without destroying the substrate—that is, it forms a watertight bond but one that may be removed without destroying the substrate.

The polymers, in some embodiments, used in these sealant devices may be infused with various insect and rodent repellant or rodent killing chemicals together known as “aversion agents.” Further, the polymers may contain known anti-fungal or anti-microbial agents (“biocides”). These will kill or slow the growth of microbes. Microbes often emit a scent that rodents can smell and are attracted to. Preventing the growth of microbes, therefore, often eliminates the rodents. Thus, these sealants, alone or in combination, form moisture and dirt barriers by coating/covering/wrapping/encapsulating, but should a critter approach, they also, by smell and/or taste, tend to discourage further contact.

Applicant provides a sealant for application to and sealing openings and devices in an electrical control box, junction of other electrical enclosures having openings, including access doors and/or electrical conduit openings, the sealant comprising, in some embodiments: a two-part polymer, the polymer including a critter aversion agent and/or an anti-microbial agent.

The sealant, in some embodiments, may be a gasket or tape that includes a skeleton, and the polymer a cured polyurethane or polyurea, the skeleton being encapsulated in the cured, polymer or polyurea, and the combination comprising a gasket or tape. The sealant may also be a two-part polymer adapted to be brushed, rolled or sprayed on a substrate for curing in-place. A two-compartment injector or applicator may be used to apply a sealant, the injector or applicator having a first compartment and a second compartment, a forcing element, and a mixing nozzle with a tip, wherein the two-part polymer is adapted to cure after exiting the mixing nozzle.

A method of using some embodiments of the sealant described may comprise the step of placing an uncured two-part polymer around, near, adjacent or in an opening of an electrical enclosure through which electrical wires or conduit run; and may also comprise, following the placing step, the step of allowing the two-part polymer to cure, so as to sea! the opening with a moisture proof seal.

A method of applying some embodiments of the sealant described may comprise the step of: encapsulating a component of the enclosure with the polymer mix exiting the nozzle and, in some embodiments, following the encapsulating step, allowing the mix to cure. The component may be a section of an electrical wire or conduit adjacent an opening of the enclosure and may further include the step of sealing the opening with the uncured mix and allowing the mix to cure. The component may be a part of an electrical terminal or power switch box.

The method in some embodiments may further comprise a step of coating any component with a coating comprising the two-part cure-in-place sealant. The coating step may be achieved using a brush, roller or atomized spray and the two-part polymer typically cures in place on the substrate.

### BRIEF DESCRIPTION OF THE DRAWINGS

FIG. 1 is a perspective view of an example of a railroad control box to which one or more of Applicant's sealant products may be applied.

FIG. 1A illustrates prior art weather stripping on a door opening of a railroad control box and FIG. 1B illustrates a cross-section of the perimeter of a door having prior art weather stripping and applicants sealant.

FIG. 2 shows an enclosure and a method of applying an uncured two part polymer to a surface or component thereof.

FIGS. 2A, 2B, and 2C show an electrical conduit and electrical wires opening into or onto which one or more of Applicant's sealants may be applied.

FIG. 3 shows an electrical terminal with or on which one or more of Applicant's sealants may be applied.

FIGS. 4A and 4B illustrate two views of a sealant gasket for use with a door closure perimeter.

FIGS. 5A and 5B illustrate two different tape or rolled sealants that may be used to help seal critter access to an electrical enclosure; FIG. 5A a stretchable tape and FIG. 5B a non-stretchable tape.

### DETAILED DESCRIPTION OF THE PREFERRED EMBODIMENT

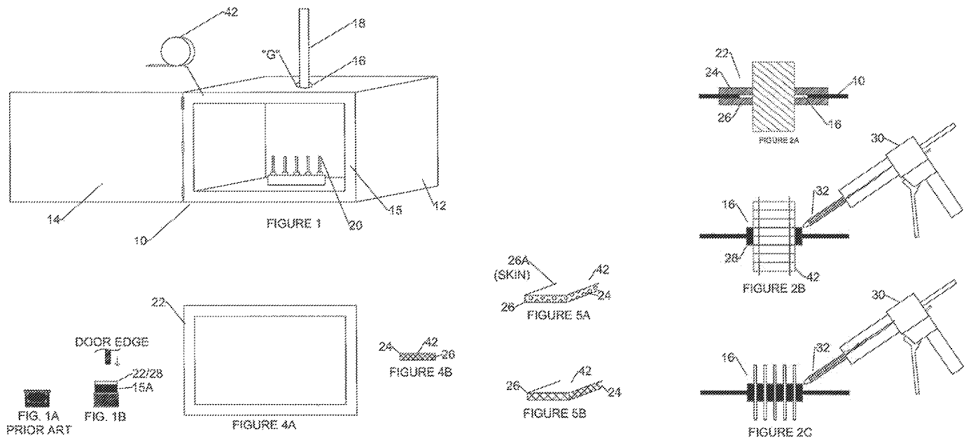

FIGS. 1, 2 and 3 show enclosure(s) 10, comprising a walled housing 12 and, in some embodiments, a door 14, and a door opening perimeter 15, which may include an OEM foam seal 15A (see FIG. 1A), such as weather stripping. The walled housing 12 may include a conduit opening 16 or other opening with a wire bundle (see FIG. 2C) or conduit 18 passing through, typically leaving a small gap “G” between the walls defining the conduit opening 16 and the outer walls of conduit 18 or other insulated electrical wire, wires or wire sheaths.

Enclosure 10 defines an inner volume or space in which various electrical terminals 20, switches or other devices, in some embodiments, useful with or for railroad (“RR”) switching, junctions PTC (Positive Train Control), crossing gates, or other external boxes or enclosures. These enclosures are typically found outside and thus are subject to assault by pernicious critters seeking food or shelter and by dust, dirt or moisture.

Applicant's several sealant products and devices, alone or in combination, can help provide a physical barrier to critter ingress, a chemical aversion agent to said critters, an anti-microbial biocide agent, and also, in some embodiments, provide corrosion protection to the enclosure 10 or any parts on or in the enclosures.

A first sealant device is a gasket 22 (example, FIG. 2), a second device is a cure-in-place applicator injected polymer 28 composition (example, FIG. 3), a third device is a thin coat 40 of a brush 44, roller 48 applied, or spray gun 46 on cure-in-place polymer composition (example, FIG. 2), and a fourth device is a tape 42 (examples, FIGS. 5A and 5B).

All of the foregoing have in common a two-part polymer matrix 24 that is either pre-cured (tape and gaskets) or cures-in-place on the substrate (injected and brush, roll or spray on coating). The polymers, once cured, are somewhat elastomeric, compressible, have hardness of a variety of ranges, adhere well (peel strength) to the metallic and/or non-metallic substrates (but do not adhesively bond to these substrates), and they seal well against ingress of moisture, they stand up to acids, bases, salts, and other structural corrosive agents. Moreover, the polymers may include a chemical aversion agent, such as a rodentcide or a critter repellant. The polymer may also contain anti-microbial (biocide) agents. In preferred embodiments, they have no VOCs (100% solids), and as such (no solvents) are considered non-hazardous. They do not require special shipping or handling and are non-combustible.

The gaskets and tapes, in some embodiments, have pre-cured polymer gel bodies and also an embedded, stretchable or substantially un-stretchable skeleton 26, which may be a webbing, mesh or foam (typically at least a partly open cell foam). Webbing, skeleton or mesh may be metallic or non-metallic, woven or non-woven, in preferred embodiments, non-metallic, including nylon, Kevlar®, and fiberglass webbing or mesh. DuraFlow® Kevlar mesh is one that may be suitable. In a preferred embodiment, the skeleton 26 is electrically non-conductive, strong, and tough but also may be conductive. The elastomeric polymer matrix typically encapsulates the skeleton. Another tough, durable rodent impenetrable mechanical barrier that may be used as a skeleton is a rodent control fill fabric called XCluder®, a combination of stainless steel and polyester fibers similar to steel wool.

Gaskets 22 are typically die cut and are seen to be used either on top of (FIG. 1B) or in place of weather stripping (FIG. 1A) or around conduit opening 16 (FIG. 2A) or any other suitable location usually between two parts under compressions. On door perimeter 15A, it will seal against the door edge (FIG. 1B), with the polymer surface depressing somewhat when the door is in a closed position, this creates a moisture and dirt tight seal (see FIG. 1B). The proper thickness of the gasket is selected to ensure contract and some deformation or indentation of the polymer as the door reaches closure. Typical thicknesses of gaskets and tape are in the range of 5-500 mil (uncompressed) (in other embodiments, 20-50 mil).

Tapes 42 (see FIGS. 5A and 5B) are similar to gaskets—in some embodiments having skeleton, and polymer matrix, but instead of being die cut, they come rolled up and are typically long, compared to width, and, in some embodiments, used to wrap conduits or other electrical wires, for helping to fill around gaps where the conduit enters an enclosure (FIG. 2B). In some embodiments, the tapes have a stretchable, polymer filled (typically saturated) foam skeleton (FIG. 5A), the cured polymer may, in some embodiments, be tacky to the touch, it will both compress somewhat but fill the gap (see FIG. 2B) and when stretched somewhat and wrapped around the electrical wire(s) in overlapping courses (see FIG. 3) will provide pressure to seal against the walls defining conduit opening 16. The foam may be open-cell or partially open-cell foam, the cells typically having pre-cured, tacky polyurethane. Some tapes contain a tough, durable skeleton (see FIG. 5B). In some embodiments, tape 42 self-amalgamating (self-fusing) tape, such as silicone-rubber tape which when stretched and wrapped around cables unites itself into a strong, seamless, rubbery, waterproof, electrically insulating layer (FIG. 3), showing both external and internal use of tape as well as using tape to close gap “G”.

FIG. 2A illustrates a pair of flat gaskets 22, one on an outside surface, the other on an inside surface of walls adjacent conduit opening 16, with a cutout or slit in the gasket so the electrical conduit 18 can pass through the gasket, but the gasket will otherwise seal the gap.

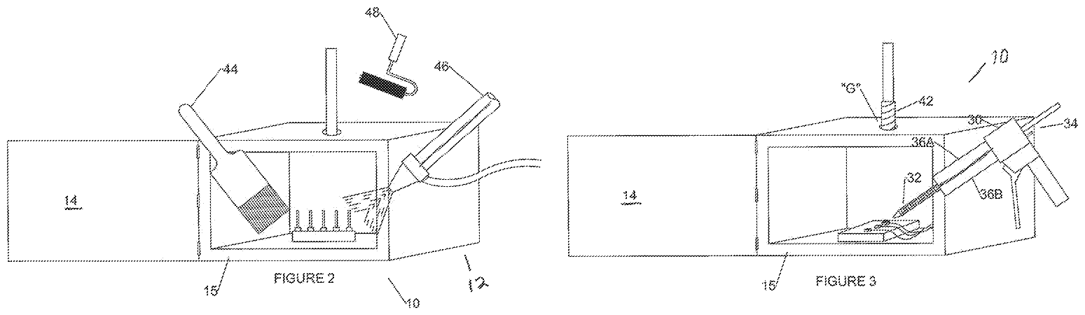

FIGS. 2, 2A, 4A, and 4B illustrate the shape of the gasket may be tailored to its use, here in FIG. 2A, a round or rectangular planar gasket shape to cover and stick to walls adjacent opening 16, or a rectangular gasket in FIGS. 4A and 4B, to fit door opening 15 and/or on OEM seal 15A. Tough and durable skeletons may be used, in some embodiments, that will stand up to the razor sharp teeth of mice. One side (typically facing out) of the gasket or tape may have a skin, such as a durable but flexible, impervious or semi-permeable, plastic or PTFE skin 26A, the tacky polymer side is usually against the structure.

FIGS. 2B, 2C, and 3 illustrate the use of Applicant's applicator or injector applied two-part CIP (cure-in-place) injectable polymer mix 28 to, in some embodiments, seal around electrical wires or conduits as they enter the enclosure. An apparatus, such as an applicator 30, having a mixing nozzle 32, and a plunger or forcing element 34, which acts on two compartments 36A/36B, each compartment having one (uncured) part of the two-part polymer, in some embodiments, the two-part polymer being a polyurethane or polyurea. As the forcing element 34 is manually pushed down, each polymer part will be forced into the mixing nozzle (also called a “mixing straw”) and will exit the tip to flow as a thick, viscous mass onto the device to be sealed, covered or encapsulated (FIG. 3) or into a gap to be filled (FIGS. 2B and 2C). The mix 28 typically will not sag on vertical surfaces (thixotropic) and may be shaped (formed) with the tip of the nozzle or with the user's fingers (before it cures). In some embodiments, the gel time of the mix is 1-10 minutes, and the cured hardness is between 40 to 90 Shore “00”, in other embodiments, greater than 60.

A number of chemical aversion agents can be used, mixed into one or both parts of the polymers before they are mixed to cure in place or pre-cured. These include peppermint oil, which acts as a safe rodent repellant and Capsaicin (in some embodiments, as microcapsules). These aversion agents may kill the rodent (rodentcides, such as brodifacoum or arsenic compounds), or be merely distasteful, like Lithium Chloride.

A brushable, roll-on or sprayable cure-in-place polymer sealant coat 40 may be used to cover any part of the enclosure or component therein. It may be used as a brush-on, roll-on or spray-on in an uncured state, and, in some embodiments, cures clear, or at least transparent. It may be sprayed, rolled or brushed on any surface, external or interior, and often is used after injectables are used to coat the surfaces to prevent moisture from contacting the surfaces (see FIG. 2). It forms a tough, flexible, barrier to protect the substrate. It also may include a chemical aversion agent or anti-microbial agent. In some embodiments, it may gel in 1 to 14 minutes or less to a hardness of Shore “A” 30-90, in other embodiments, greater than 40 Shore “A”. The tape or gasket may be compressible, in some embodiments compressible to between 10% and 80% of its initial thickness at pressures between 2-10 psi.

The cure in place or precured polymer may contain ultraviolet (UV) light inhibitors such as carbon black particles loaded to 0.50-2% by weight of the mix. All polymers are preferably 100% solids (no volatiles). The polymer used is typically elastomeric when cured with a cured hardness between 30 and 95 shore “00” (injectables); 45-125 37.5-gram half cone penetrometer (the polymer gel bodies of the tape and gaskets) and 30-90 shore “A” (sprayable and injectables). All measured 24 hours after mixing at 77° Fahrenheit.

The injectables may be polyurea or polyurethane (two-part). The polyurea may have a peel-strength of 10-30 piw (pounds per inch width) (90° peel back off of clean aluminum), the polyurethane between 0.5 and 5 piw and is self-leveling. The injectable typically reach full cure in 2-240 minutes. The peel-strength of the sprayable may be 1-5 piw and the gel time 8 to 14 minutes (10-gram mass at 77° F.). The peel-strength of the tape may be 0.10-0.50 piw, and elasticity between 150-350%. Peel strength measured after full cure.

A spray cartridge is constructed like the applicator but, in come embodiments, is configured to engage a pneumatic spray gun such as a Sulzer 06114420-28 or 06114420-03 which provides mechanical rather than manual force to the forcing element and compressed air to the tip of the nozzle to atomize the mix as it comes out of the tip.

Biocides are provided in the polymer. One biocide is Vinyzene® SB-1 PR a concentrate of 10,10′-oxybisphenoxarsine. The pelletized form can be mixed with polymers. The biocide is mixed at 5% to 95% of the polymer. Vinyzene® is also available in 1% and 2% solutions in plasticizers and solvents. Other examples of biocides are Zinc Omadine manufactured by Olin Chemical, Zinc Tryithione; and Intercide TMP by Akzochemie America, N-trichloromethylthiophthalimide. These compounds are exemplary of the biocides which can be used in this invention and other biocides may be used. Other biocides may be found in U.S. Pat. Nos. 4,988,236 and 5,178,495 incorporated herein by reference.

Injectables may be two component cure-in-place applicator applied polyurea or polyurethane. One part may be resin, viscosity 18000-28000 cps, one part hardener, viscosity 25,000-42,000 cps (77° F.) for the polyurea. The uncured mix is a thick, viscous mass. The polyurethane resin is 1,500-2,500 cps and hardener is 3,300-4,300 cps, the uncured mix less viscous that the polyurea. Both pass ASTMB117, no corrosion after 3,000 hours in salt fog. The sprayable is a two-component polyurea that is even less viscous than the polyurethane injectable, passes the salt fog and 12-second vertical burn at 0.060″, 0.080″ and 0.235″ (14 CFR, part 25, subpart D, section 25.853(a) Appendix F, part 1A(1)(ii)).

Tapes may be skinned on one, none or all sides, and have low water absorption, in some embodiments, 1% or less, 168-hour immersion (ASTM D-543). Service temperature on all sealants are: −85° F. to +275° F. (except self-fusing tape) and shelf-life is indefinite.

In the preceding description, for purposes of explanation, numerous details are set forth in order to provide a thorough understanding of the embodiments. However, it will be apparent to one skilled in the art that these specific details are not required. In other instances, well-known structures and components are shown in block diagram form in order not to obscure the understanding.

The above-described embodiments are intended to be examples only. Alterations, modifications and variations can be affected to the particular embodiments by those of skill in the art. The scope of the claims should not be limited by the particular embodiments set forth in the examples but should be given the broadest interpretation consistent with the specification as a whole.

1. A sealant assembly for application to a railroad control box having insulated electrical wires, the control box being exposed to an outdoor environment, the sealant assembly comprising:
a first tape, the first tape being comprised of a cured polymer and a skeleton, the first tape being stretchable, waterproof, and adapted to be removably placed adjacent an electrical wire of the control box.

2. The sealant assembly of claim 1 further comprising a second tape, the second tape being stretchable and waterproof for placement adjacent the first tape.

3. The sealant assembly of claim 1 where in the first tape has a peel strength of 0.10 to 0.50 piw.

4. The sealant assembly of claim 1 wherein the cured polymer of the first tape has a hardness of 45-125 half cone penetrometer.

5. The sealant assembly of claim 1 wherein the skeleton is a nonmetal skeleton.

6. The sealant assembly of claim 1 wherein the skeleton is mesh.

7. The sealant assembly of claim 1 wherein the skeleton is foam.

8. The sealant assembly of claim 1 further including either a critter or a microbe resistant substance.

9. The sealant assembly of claim 8 wherein the microbe resistant substance includes a biocide.

10. The sealant assembly of claim 8 wherein the microbe resistant substance includes an antifungal substance.

11. The sealant assembly of claim 2 wherein the first tape includes a foam skeleton.

12. The sealant assembly of claim 2 wherein the cured polymer of the first tape has a hardness of 45 to 125 half cone penetrometer.

13. The sealant assembly of claim 2 wherein the first tape is tacky.

14. A sealant assembly for application to a railroad control box having insulated electrical wires, the control box being exposed to an outdoor environment, the sealant assembly comprising:
a first tape, the first tape being comprised of a cured polymer and a skeleton, the first tape being stretchable, waterproof, and adapted to be removably placed adjacent an electrical wire of the control box; and
a second tape, the second tape being stretchable and waterproof for placement adjacent the first tape.

15. The sealant assembly of claim 14 wherein the skeleton is a foam and further including a critter or a microbe resistant substance.

16. The sealant assembly of claim 14 wherein the cured polymer of the first tape has a hardness of 45 to 125 half cone penetrometer and the skeleton is foam.

17. The sealant assembly of claim 14 wherein the skeleton of the first tape is a mesh or a foam and wherein the first tape has low water absorption.

18. The sealant assembly of claim 14 wherein the polymer further includes an anti-corrosive substance.

19. The sealant assembly of claim 14 wherein the polymer of the first tape is tacky to the touch.

20. The sealant assembly of claim 14 wherein one or both sides of the first tape include a skin.

21. A tape assembly for use adjacent an insulated electrical wire of a railroad control box, the tape assembly comprising:
a first tape adjacent the insulated electrical wire, the first tape being comprised of a cured polymer and a stretchable skeleton, the polymer being adapted to be removable from the insulation of the insulated electrical wire, the first tape being waterproof;
the tape assembly further comprising a second tape, the second tape being self-fusing and stretchable and adapted to be received upon the first tape compressably, the second tape being waterproof.
